(19) United States
(12) Patent Application Publication
(10) Pub. No.: US 2023/0245069 A1
(43) Pub. Date: Aug. 3, 2023

(54) SYSTEM FOR PROVIDING STABLE SALARY BASED ON PREDICTED FUTURE INCOME AND METHOD THEREOF

(71) Applicant: ENTERPRISE BLOCKCHAIN CO., LTD., Seoul (KR)

(72) Inventors: Youngseok HAN, Hwaseong-si (KR); Jihyun LEE, Yongin-si (KR); Yongwook KIM, Seoul (KR); Donghyun KIM, Yongin-si (KR); Junsup LEE, Seoul (KR); Nayoung YOUK, Seoul (KR); Taeho GWAK, Seoul (KR)

(73) Assignee: ENTERPRISE BLOCKCHAIN CO., LTD., Seoul (KR)

(21) Appl. No.: 18/009,925

(22) PCT Filed: Jul. 6, 2021
(86) PCT No.: PCT/KR2021/008547

§ 371 Date: Dec. 12, 2022

(30) Foreign Application Priority Data
Jul. 9, 2020 (KE) 10-2020-0084814

(51) Int. Cl. G06Q 10/1091; G06Q 40/12

(52) U.S. Cl. CPC G06Q 10/1091; G06Q 40/125

(57) ABSTRACT

Disclosed are a system for providing stable salary and a method therefor, the system comprising: an input unit that receives, as an input, a salary payment date having a predetermined cycle, on the basis of an external input; a learning data acquisition unit that acquires learning data including worker information, work history information, and salary history information, on the basis of the external input; a future credit period acquisition unit that determines a future credit period on the basis of at least one of the pieces of learning data; a future income prediction unit that performs machine learning by using at least one of the pieces of learning data, and predicts future income for the future credit period; and a virtual salary determination unit that, when the amount of a worker's salary is less than the target amount of salary at a specific point in time of payment of salary, determines virtual salary in which the insufficient amount of salary in the target amount of salary has been covered on the basis of the future income.

### CROSS-REFERENCE TO RELATED APPLICATION

The instant patent application claims priority under 35 U.S.C. 119(a) to Korean Patent Application No. 10-2020-0084814, filed on Jul. 9, 2020, in the Korean Intellectual Property Office, the disclosure of which is herein incorporated by reference in its entirety. The present patent application claims priority to other applications to be filed in other countries, the disclosures of which are also incorporated by reference herein in their entireties.

### TECHNICAL FIELD

The present invention relates to a system and method for providing stable salary through prediction of future income, and more particularly, a stable salary providing system and method for predicting a worker's future income for a future credit period and, when the worker's salary at a specific pay time is less than a target salary, determining and providing a virtual salary obtained by compensating for the deficit in the salary based on the future income.

### BACKGROUND ART

The gig economy is emerging as a new labor trend as the demand for labor required for on-demand services increases along with the vitalization of the on-demand economy. Gig economy refers to a type of economy in which companies hire workers as short-term contract workers or temporary workers as needed and pay them. The term ‘gig’ means temporary work. In the past, it was used to encompass various freelancers and self-employed workers, but as the on-demand economy spreads, it has recently changed to mean a provider (or gig worker) who provides services under short-term contracts with online platform companies.

In the conventional employment system, the company directly hires employees, makes a formal labor contract, and provides products or services to customers using the retained labor force. On the other hand, in the gig economy, companies use workers under ultra-short-term contracts according to demand. In the gig economy system, workers are not employed by anyone, but are temporarily hired only during a desired period of time when needed and create income through the labor desired by customers, that is, labor demanders.

Since the labor activities and earned income of these workers are irregular, there is needed a method that may provide stable income and dynamic financial services to workers. Further, to maintain or enhance the real wage, which is the basis of the worker's stable income, a service to expand the working opportunity for the worker is required to induce the maintenance or increase of the worker's real wage in advance.

### DETAILED DESCRIPTION OF THE INVENTION

### Technical Problem

The present invention has been devised to respond to the above-described technical problem and provides a stable salary providing system and method for predicting a worker's future income for a future credit period and, when the worker's salary at a specific pay time is less than a target salary, determining and providing a virtual salary obtained by compensating for the deficit in the salary based on the future income and a computer-readable recording medium recording a program to execute the method.

### Technical Solution

According to an embodiment of the present invention, a stable salary providing system comprises an input unit receiving a payday of a predetermined cycle based on an external input, a learning data obtaining unit obtaining learning data including worker information, work history information, and salary history information, based on an external input, a future credit period obtaining unit determining a future credit period based on at least one of the learning data, a future income predicting unit performing machine learning using at least one of the learning data and predicting future income for the future credit period, and a virtual salary determining unit determining a virtual salary obtained by compensating for a deficit in a target salary based on the future income when a worker's salary at a specific pay time is less than the target salary.

According to an embodiment of the present invention, the target salary is input based on an external input by the input unit or is determined using at least one of the learning data.

According to an embodiment of the present invention, the future income predicting unit predicts a plurality of future salaries respectively for a plurality of paydays of the predetermined cycle within the future credit period and predicts a sum of the plurality of future salaries within the future credit period as the future income.

According to an embodiment of the present invention, the future income predicting unit calculates the future income minus the sum of the plurality of target salaries within the future credit period as a future credit limit.

According to an embodiment of the present invention, the stable salary providing system further comprises a target salary adjustment unit reducing the target salary by a predetermined rate when the future credit limit is 0 or less. The future income predicting unit calculates the future income minus the sum of the plurality of reduced target salaries within the future credit period as the future credit limit.

According to an embodiment of the present invention, the future income predicting unit determines a minimum target salary based on one of an external input, the learning data, and the target salary. The reduction of the target salary by the target salary adjustment unit and the calculation of the future credit limit by the future income predicting unit when the future credit limit is 0 or less are repeated when the reduced target salary is larger than the minimum target salary.

According to an embodiment of the present invention, the virtual salary determining unit determines the virtual salary obtained by compensating for the smaller of the deficit and the future credit limit in the salary.

According to an embodiment of the present invention, the stable salary providing system further comprises a loan unit automatically generating a loan using the smaller of the deficit and the future credit limit as a loan amount. The virtual salary is the salary plus the loan amount.

According to an embodiment of the present invention, the stable salary providing system further comprises an investment linking unit further providing a user interface to link a remainder of the future credit limit, not covered in the virtual salary, as a first investment amount, to an investment product or automatically investing in a predetermined investment product.

According to an embodiment of the present invention, when the worker's salary exceeds the target salary, the investment linking unit further provides a user interface to link the excess, as a second investment amount, to an investment product or automatically invests in a predetermined investment product.

According to an embodiment of the present invention, the stable salary providing system further comprises an output unit outputting a total investment amount including the first investment amount and the second investment amount and the future credit limit.

According to an embodiment of the present invention, the stable salary providing system further comprises an information providing unit providing job information or recommending a job.

According to an embodiment of the present invention, the worker information includes at least one of age, gender, photo, location information, preferred occupation, preferred area, and preferred time range. The work history information includes at least one of working days, working hours, and working patterns indicating working hours for a predetermined period. The salary history information includes at least one of a plurality of past salary amounts and a salary pattern indicating salary amounts for a predetermined period.

According to an embodiment of the present invention, the information providing unit provides job information or recommends a job based on at least one of the worker information, the work history information, and the salary history information when the worker's salary is less than the target salary or the future credit limit is 0 or less.

According to an embodiment of the present invention, a stable salary providing method comprises receiving a payday of a predetermined cycle based on an external input, by an input unit, obtaining learning data including worker information, work history information, and salary history information, based on an external input, by a learning data obtaining unit, determining a future credit period based on at least one of the learning data, by a future credit period obtaining unit, performing machine learning using at least one of the learning data and predicting future income for the future credit period, by a future income predicting unit, and determining a virtual salary obtained by compensating for a deficit in a target salary based on the future income when a worker's salary at a specific pay time is less than the target salary, by a virtual salary determining unit.

According to an embodiment of the present invention, the target salary is input based on an external input by the input unit or is determined using at least one of the learning data.

According to an embodiment of the present invention, predicting the future income includes predicting a plurality of future salaries respectively for a plurality of paydays of the predetermined cycle within the future credit period and predicting a sum of the plurality of future salaries within the future credit period as the future income.

According to an embodiment of the present invention, predicting the future income further includes calculating the future income minus the sum of the plurality of target salaries within the future credit period as a future credit limit.

According to an embodiment of the present invention, the stable salary providing method further comprises reducing the target salary by a predetermined rate when the future credit limit is 0 or less, by a target salary adjustment unit. Predicting the future income further includes calculating the future income minus the sum of the plurality of reduced target salaries within the future credit period as the future credit limit.

According to an embodiment of the present invention, the stable salary providing method further comprises determining a minimum target salary based on one of an external input, the learning data, and the target salary, by the future income predicting unit. Reducing the target salary by the predetermined rate and calculating the future credit limit when the future credit limit is 0 or less are repeated when the reduced target salary is larger than the minimum target salary.

According to an embodiment of the present invention, determining the virtual salary determines the virtual salary obtained by compensating for the smaller of the deficit and the future credit limit in the salary.

According to an embodiment of the present invention, the stable salary providing method further comprises automatically generating a loan using the smaller of the deficit and the future credit limit as a loan amount, by a loan unit. The virtual salary is the salary plus the loan amount.

According to an embodiment of the present invention, the stable salary providing method further comprises providing a user interface to link a remainder of the future credit limit, not covered in the virtual salary, as a first investment amount, to an investment product or automatically investing the first investment amount in a predetermined investment product, by an investment linking unit.

According to an embodiment of the present invention, the stable salary providing method further comprises, when the worker's salary exceeds the target salary, providing a user interface to link the excess, as a second investment amount, to an investment product or automatically investing the second investment amount in a predetermined investment product.

According to an embodiment of the present invention, the stable salary providing method further comprises outputting a total investment amount including the first investment amount and the second investment amount and the future credit limit, by an output unit.

According to an embodiment of the present invention, the stable salary providing method further comprises providing job information or recommending a job, by an information providing unit.

According to an embodiment of the present invention, the worker information includes at least one of age, gender, photo, location information, preferred occupation, preferred area, and preferred time range. The work history information includes at least one of working days, working hours, and working patterns indicating working hours for a predetermined period. The salary history information includes at least one of a plurality of past salary amounts and a salary pattern indicating salary amounts for a predetermined period.

According to an embodiment of the present invention, providing the job information or recommending the job provides job information or recommends a job based on at least one of the worker information, the work history information, and the salary history information when the worker's salary is less than the target salary or the future credit limit is 0 or less.

Further, according to an embodiment of the present invention, there is included a computer-readable recording medium recording a program for performing the method.

### Advantageous Effects

According to the present invention, a future credit limit which is financially reliable is calculated from a worker's irregular past work activities, and a virtual salary for compensating for the current income based on the future credit limit is provided. Thus, it is possible to mitigate degradation of the worker's life quality due to irregular income.

Further, according to the present invention, the remaining future credit limit after providing the virtual salary, from the worker's future credit limit or the worker's salary exceeding the target salary is led to automated investment so that labor income is simply linked to investment. This helps the worker's financial growth.

Further, according to the present invention, when it is determined that the target salary needs to be reduced since the worker's salary is less than the target salary or the current income cannot be compensated even based on the future credit limit, it is possible to enhance the worker's salary by providing job information to the worker or recommending a job.

### BRIEF DESCRIPTION OF DRAWINGS

FIG. 1 is a block diagram schematically illustrating a stable salary providing system according to an embodiment of the present invention;

FIG. 2 is a flowchart schematically illustrating a stable salary providing method according to an embodiment of the present invention;

FIG. 3 illustrates a procedure for predicting a future income and determining a virtual salary based on the future income in a stable salary providing method according to an embodiment of the present invention;

FIG. 4 illustrates a user interface (UI) to output a worker's salary, deficit in salary, total investment amount, and future credit limit at a specific time according to an embodiment of the present invention;

FIG. 5 illustrates a user interface to receive a target salary and a payday at a specific cycle according to an embodiment of the present invention;

FIG. 6 illustrates a user interface to indicate that, when a worker's salary exceeds a target salary, the excess amount has been automatically invested according to an embodiment of the present invention;

FIG. 7 illustrates a user interface to output a worker's total investment amount and investment details according to an embodiment of the present invention;

FIG. 8 illustrates a user interface to receive a virtual salary to compensate for a deficit in salary when a worker's salary is less than a target salary according to an embodiment of the present invention;

FIG. 9 illustrates a user interface to output a worker's future credit limit and details of a loan made based on the future credit limit according to an embodiment of the present invention;

FIG. 10 illustrates a user interface to provide job information and receive a job recommendation input according to an embodiment of the present invention;

FIG. 11 illustrates a user interface to receive worker information for job recommendation and output a recommended job;

FIG. 12 illustrates a user interface to output detailed information about a recommended job and receive a job application according to an embodiment of the present invention;

FIG. 13 illustrates a user interface to apply for a predetermined standard of job according to an embodiment of the present invention; and

FIG. 14 illustrates a user interface to output work history information about a specific job according to an embodiment of the present invention.

### MODE FOR CARRYING OUT THE INVENTION

Hereinafter, preferred embodiments of the present invention are described in detail with reference to the accompanying drawings. In the drawings, the same reference numerals refer to the same elements, and the size of each component in the drawings may be exaggerated for clarity of description.

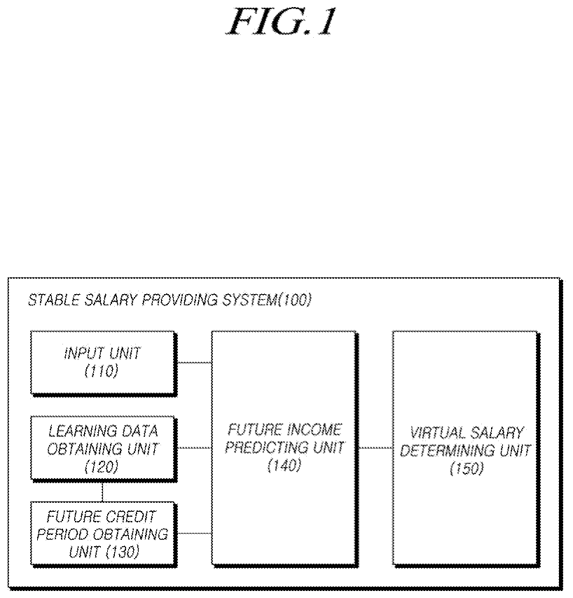

FIG. 1 is a block diagram schematically illustrating a stable salary providing system according to an embodiment of the present invention.

According to an embodiment of the present invention, a stable salary providing system 100 includes an input unit 110, a learning data obtaining unit 120, a future credit period obtaining unit 130, a future income predicting unit 140, and a virtual salary determining unit 150.

According to an embodiment of the present invention, the stable salary providing system 100 may further include a target salary adjustment unit (not shown), a loan unit (not shown), an investment linking unit (not shown), an output unit (not shown), and an information providing unit (not shown).

The input unit 110 receives a payday of a predetermined cycle based on an external input. For example, when the salary is paid on a weekly basis, a specific day of the week is input and, when the salary is paid on a monthly basis, a specific date is input.

The learning data obtaining unit 120 obtains learning data including worker information, work history information, and salary history information, based on an external input. The worker information includes at least one of age, gender, photo, location information, preferred occupation, preferred area, and preferred time range. The work history information includes at least one of working days, working hours, and working patterns indicating working hours for a predetermined period. For example, the working pattern may be a pattern of working hours of 30, 45, 52, and 70 hours per week over a four-week period. The salary history information includes at least one of a plurality of past salary amounts and a salary pattern indicating salary amounts for a predetermined period. For example, the salary pattern may be a pattern of salary amounts, such as 1 million won, 3 million won, 4 million won, 2 million won, and 5 million won per month for a period of 5 months.

The future credit period obtaining unit 130 determines a future credit period based on at least one of the pieces of learning data. The future credit period obtaining unit 130 calculates a future income pattern (a plurality of future salaries) for each of candidate future credit periods based on at least one of the pieces of learning data. The future credit period obtain unit 130 calculates a prediction error value of the future income pattern for each of the candidate future credit periods and determines that the maximum future credit period among candidate future credit periods in which the prediction error value meets a predetermined prediction error range (error margin) is the future credit period. For example, worker A regularly works 70 to 80 hours per month for 24 months and has a steady monthly salary between 450 million won to 600 million won. Given the error margin, worker A's future credit period may be calculated as eight months. As another example, worker B works 50 hours in the first month, 10 hours in the second month, 0 hours in the third month, and 12 hours in the fourth months over four months and monthly earns 200 million won, 400,000 won, 0 won and 500,000 won for the respective months. Due to irregular earnings, the prediction error has increased, and considering the error margin, worker B's future credit period may be calculated as two months.

The future income predicting unit 140 may perform machine learning using at least one of the pieces of learning data and predicts future income for the future credit period. The machine learning includes a scheme that calculates a pattern according to conditions by, e.g., statistical methods, support vector machine (SVM), principal component analysis (PCA), Bayesian classifier, matrix factorization, supervised or unsupervised classification of data, and dimension reduction and predicts a future pattern according to the pattern. The prediction of the future pattern may use at least one of neural network techniques, such as a hidden Markov model (HMM), a long short term memory (LSTM), a convolutional neural network (CNN), and a Boltzmann machine, but is not limited thereto. It is apparent to one of ordinary skill in the art that any technique capable of using ambient information for increasing prediction accuracy and calculating prediction information from data may be adopted.

The future income predicting unit 140 predicts a plurality of future salaries respectively for a plurality of paydays of the predetermined cycles within the future credit period and predicts the sum of the plurality of future salaries within the future credit period as the future income. For example, when the salary is paid on a weekly basis, the sum of 10 future salaries for a 10-week future credit period is predicted as the future income.

The future income predicting unit 140 calculates the future income minus the sum of a plurality of target salaries within the future credit period as the future credit limit. The target salary is input based on an external input by the input unit or is determined using at least one of the pieces of learning data. For example, the target salary may be determined as an average of a plurality of past salaries corresponding to a predetermined working period of the worker. In calculating the future credit limit, if the future income is calculated as the future credit limit, the worker may freely use the future income, and thus a situation in which a virtual salary cannot be provided in the future may occur. Accordingly, the future income predicting unit 140 calculates the future income minus the sum of a plurality of target salary amounts within the future credit period as the future credit limit.

When the future credit limit is 0 or less, the target salary adjustment unit reduces the target salary by a predetermined rate. The future income predicting unit 140 calculates the future income minus the sum of the plurality of the reduced target salaries within the future credit period as the future credit limit. The reduction of the target salary by the target salary adjustment unit and the calculation of the future credit limit by the future income predicting unit when the future credit limit is 0 or less are repeated when the reduced target salary is larger than the minimum target salary. The minimum target salary is determined by the future income predicting unit based on one of an external input, the learning data, and the target salary.

The virtual salary determining unit 150 determines a virtual salary that compensates for the deficit in the target salary based on the future income when the worker's salary at a specific pay time is less than the target salary. Specifically, the virtual salary determining unit 150 determines a virtual salary obtained by compensating for the smaller of the deficit in the target salary and the future credit limit, for the salary amount. The loan unit (not shown) automatically generates a loan that takes the smaller of the deficit in the target salary and the future credit limit as the loan amount. The virtual salary is the salary plus the loan amount. If the future credit limit cannot cover the entire deficit in the target salary, the virtual salary will be determined as an amount that is less than the target salary.

The investment linking unit (not shown) provides a user interface linking the remainder of the future credit limit, which is not used for compensation into the virtual salary, as a first investment amount, to an investment product or automatically invests in a predetermined investment product. When the worker's salary at a specific pay time exceeds the target salary, the investment linking unit (not shown) provides a user interface linking the excess amount, as a second investment amount, to an investment product or automatically invests in a predetermined investment product. The investment linking unit (not shown) may automatically determine the predetermined investment product based on at least one of the learning data and a future income pattern (a plurality of future salaries).

The output unit (not shown) outputs the total investment amount including the first investment amount and the second investment amount and the future credit limit.

The information providing unit (not shown) outputs the required amount of work considering the target salary, provides job information or recommends jobs. The information providing unit (not shown) provides job information or recommends jobs based on at least one of the worker information, the work history information, and the salary history information when the worker's salary is less than the target salary or the future credit limit is 0 or less.

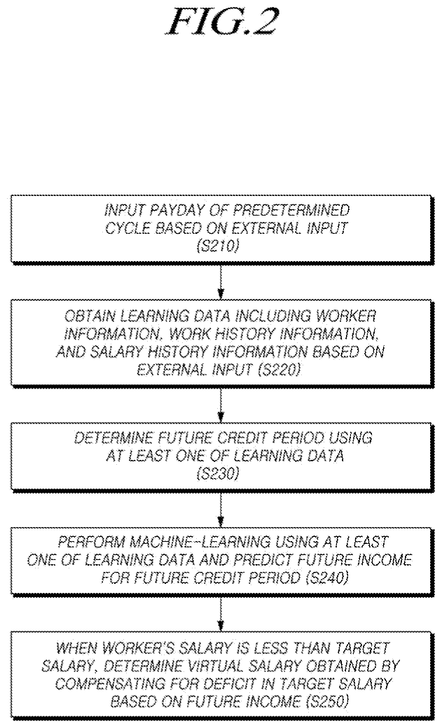

FIG. 2 is a flowchart schematically illustrating a stable salary providing method according to an embodiment of the present invention.

In step S210, the stable salary providing system 100 receives, by the input unit, a payday of a predetermined cycle based on an external input.

In step S220, the stable salary providing system 100 obtains, by the learning data obtaining unit, learning data including worker information, work history information, and salary history information, based on an external input. The worker information includes at least one of age, gender, photo, location information, preferred occupation, preferred area, and preferred time range. The work history information includes at least one of working days, working hours, and working patterns indicating working hours for a predetermined period. The salary history information includes at least one of a plurality of past salary amounts and a salary pattern indicating salary amounts for a predetermined period.

In step S230, the stable salary providing system 100 determines, by the future credit period obtaining unit, a future credit period based on at least one of the pieces of learning data.

In step S240, the stable salary providing system 100 performs machine learning using at least one of the pieces of learning data and predicts the future income for the future credit period by the future income predicting unit.

In step S250, the stable benefit providing system 100 determines, by the virtual salary determining unit, a virtual salary obtained by compensating for the deficit in the target salary based on the future income when the worker's salary is less than the target salary. The target salary is input based on an external input by the input unit or is determined using at least one of the pieces of learning data.

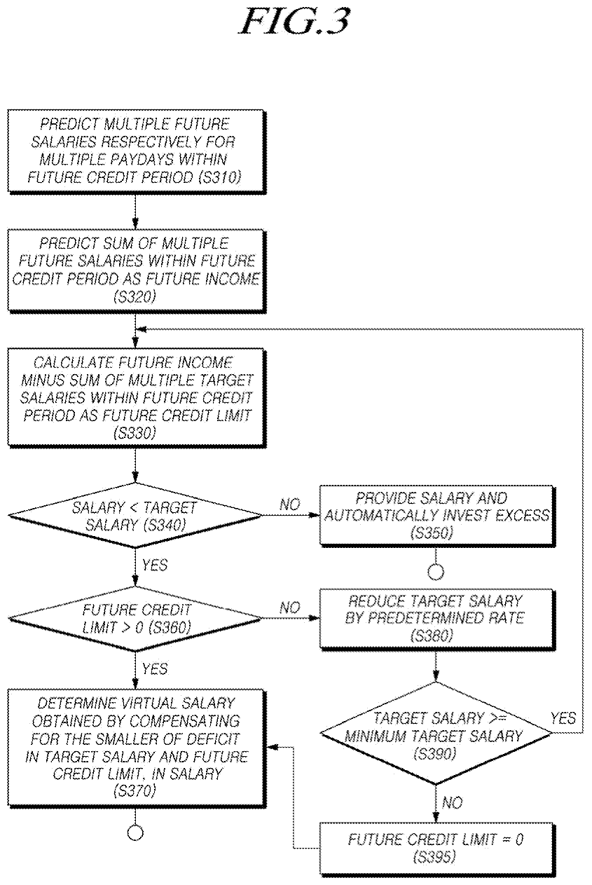

Specific procedures of steps S240 and S250 are described below with reference to FIG. 3.

FIG. 3 illustrates a procedure for predicting a future income and determining a virtual salary based on the future income in a stable salary providing method according to an embodiment of the present invention.

In step S310, the stable salary providing system 100 predicts, by the future income predicting unit, a plurality of future salaries respectively for the plurality of paydays of the predetermined cycles within the future credit period.

In step S320, the stable salary providing system 100 predicts the sum of the plurality of future salaries within the future credit period as the future income, by the future income predicting unit.

In step S330, the stable salary providing system 100 calculates the future income minus the sum of the plurality of target salaries within the future credit period, as the future credit limit, by the future income predicting unit.

In step S340, the stable salary providing system 100 determines whether the worker's salary at a specific pay time is less than the target salary. When the worker's salary is less than the target salary, the procedure goes to step S360, otherwise, to step S350.

In step S350, the stable salary providing system 100 pays the target salary to the worker. The stable salary providing system 100 automatically invests the salary exceeding the target salary, as the second investment amount, in a predetermined investment product. Alternatively, the stable salary providing system 100 may provide a user interface to link the second investment amount to an investment product, by the investment linking unit. The stable salary providing system 100 may automatically determine the predetermined investment product based on at least one of the learning data and a future income pattern (a plurality of future salaries).

In step S360, the stable salary providing system 100 determines whether the future credit limit is larger than 0. When the future credit limit is larger than 0, the procedure goes to step S370, otherwise, to step S380.

In step S370, the stable salary providing system 100 determines a virtual salary obtained by compensating for the smaller of the deficit in the target salary and the future credit limit, for the salary amount.

The stable salary providing system 100 automatically generates, by the loan unit, a loan that takes the smaller of the deficit in the target salary and the future credit limit as the loan amount. The virtual salary is the salary plus the loan amount.

The stable salary providing system 100 provides a user interface linking the remainder of the future credit limit, which is not used for compensation into the virtual salary, as a first investment amount, to an investment product or automatically invests in a predetermined investment product, by the investment linking unit. The stable salary providing system 100 may automatically determine the predetermined investment product based on at least one of the learning data and a future income pattern (a plurality of future salaries).

In step S380, the stable salary providing system 100 reduces the target salary by a predetermined rate, by the target salary adjustment unit. For example, when the target salary is 3 million won, the stable salary providing system 100 may reduce the target salary by 10% into 2.7 million won.

In step S390, the stable salary providing system 100 determines whether the reduced target salary is a minimum target salary or more. When the reduced target salary is the minimum target salary or more, the stable salary providing system goes to step S330, otherwise to step S395. The minimum target salary is determined by the future income predicting unit based on one of an external input, the learning data, and the target salary.

In step S395, the stable salary providing system 100 sets the future credit limit to 0 and goes to step S370.

In step S360, when the future credit limit is 0 or less, the step S380 of reducing the target salary by the predetermined rate and the step S330 of calculating the future credit limit may be repeated if the reduced target salary is larger than the minimum target salary.

The stable salary providing system 100 further includes the step of outputting the total investment amount including the first investment amount and the second investment amount and the future credit limit by the output unit.

The stable salary providing system 100 further includes the step of outputting a required amount of work considering the target salary and providing job information or recommending jobs, by the information providing unit. The step of providing job information or recommending jobs provides job information or recommends jobs based on at least one of the worker information, the work history information, and the salary history information when the worker's salary is less than the target salary in step S340 or the future credit limit is 0 or less in step S360.

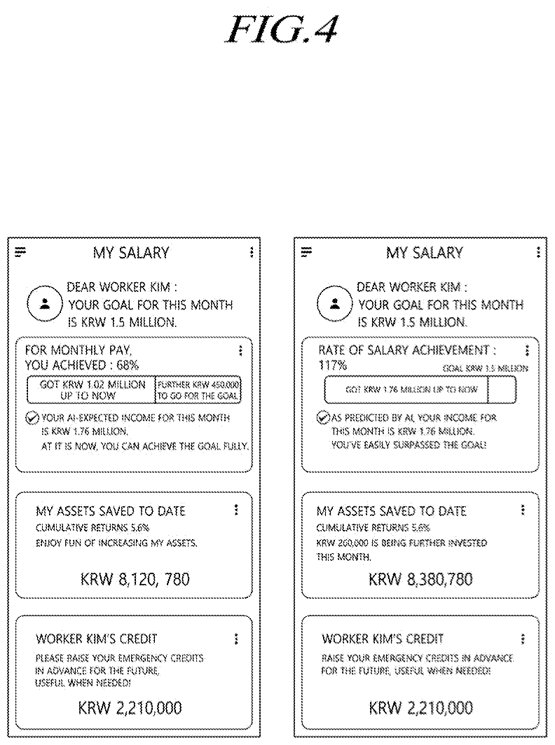

FIG. 4 illustrates a user interface (UI) to output a worker's salary, deficit in salary, total investment amount, and future credit limit at a specific time according to an embodiment of the present invention.

In the two examples shown, for worker Kim, the target salary is 1.5 million won, and salaries at specific times are 1.02 million won and 1.76 million won, respectively. The deficit in the target salary is 480,000 won, the total investments are 8,120,780 won and 8,380,780 won, respectively, and the future credit limit is 2,210,000 won. In the example shown, the future salary of the pay cycle to which the search time belongs is predicted to be 1.76 million won.

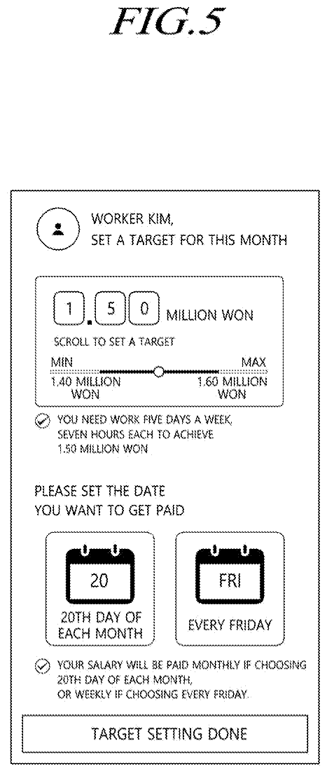

FIG. 5 illustrates a user interface to receive a target salary and a payday at a specific cycle according to an embodiment of the present invention.

In the example shown, worker Kim entered a target salary of 1.5 million won. In the shown example, the stable salary providing system 100 set a range between the minimum target salary and the maximum target salary based on one of an external input and the learning data and was allowed to enter a target salary based on an external input within the range. Worker Kim may enter the payday as monthly or weekly.

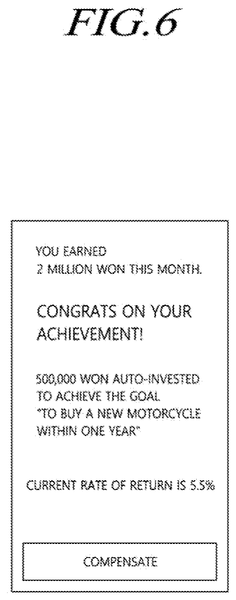

FIG. 6 illustrates a user interface to indicate that, when a worker's salary exceeds a target salary, the excess amount has been automatically invested according to an embodiment of the present invention.

In the illustrated example, a notification that 500,000 won which is excess of the target salary is automatically invested in a predetermined investment product and the current rate of return may be seen. The stable salary providing system 100 may automatically determine the predetermined investment product based on at least one of the learning data and a future income pattern (a plurality of future salaries).

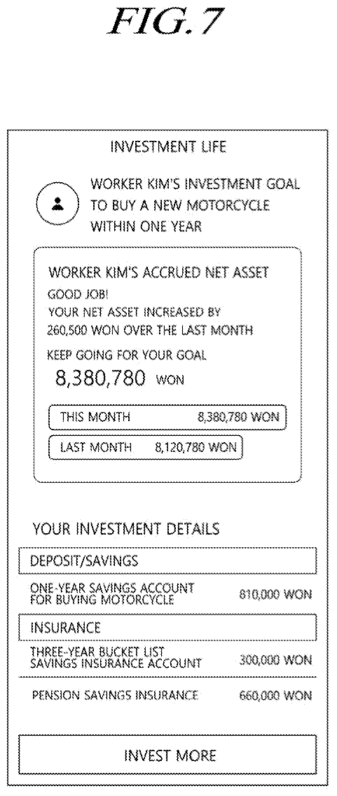

FIG. 7 illustrates a user interface to output a worker's total investment amount and investment details according to an embodiment of the present invention.

In the illustrated example, the total investment amount at the time of search by worker Kim, 8,380,780 won, and investment details including investment products and money are output.

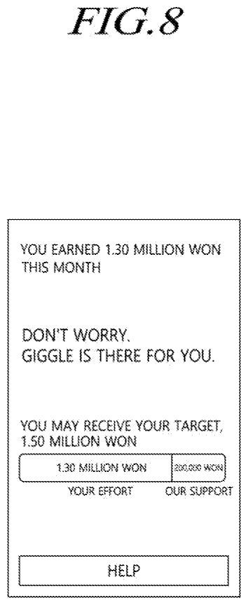

FIG. 8 illustrates a user interface to receive a virtual salary to compensate for a deficit in salary when a worker's salary is less than a target salary according to an embodiment of the present invention.

In the illustrated example, since the worker's salary (1.3 million won) is less than the target salary (1.5 million won) at the time of search, an input button for receiving a virtual salary that compensates for the insufficient salary is output.

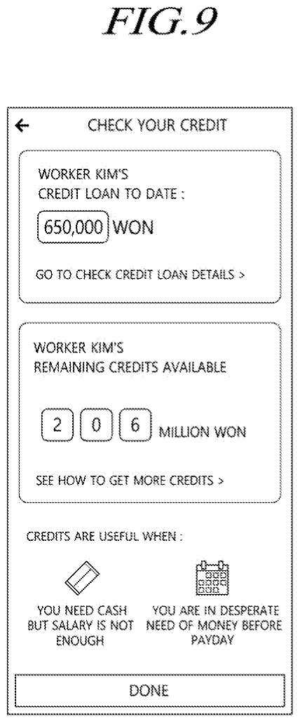

FIG. 9 illustrates a user interface to output a worker's future credit limit and details of a loan made based on the future credit limit according to an embodiment of the present invention.

In the illustrated example, it may be seen that the worker's future credit limit is 2.06 million won, and the loan amount already borrowed by the worker is 650,000 won.

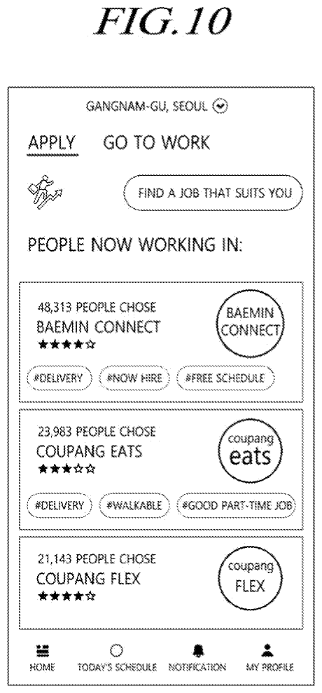

FIG. 10 illustrates a user interface to provide job information and receive a job recommendation input according to an embodiment of the present invention.

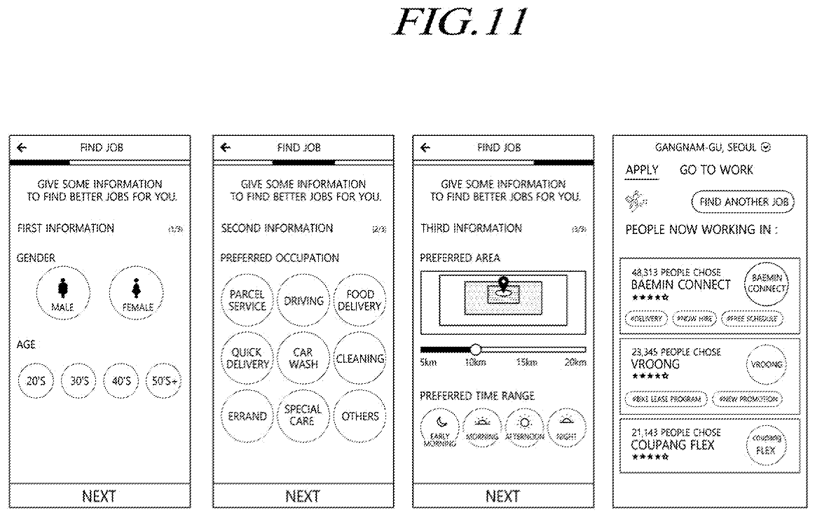

In the illustrated example, job information is output in the order from the job most applied for by workers. The worker may receive a job recommendation by pressing the “Find a job that suits me” button, and the next user interface is described below with reference to FIG. 11.

FIG. 11 illustrates a user interface to receive worker information for job recommendation and output a recommended job.

In the illustrated example, to receive a job recommendation, the worker enters age, gender, preferred occupation, preferred area, and preferred time range. The preferred area may be set to be within a predetermined range as default, based on the location information about the worker. Based on the worker information, recommended jobs are output.

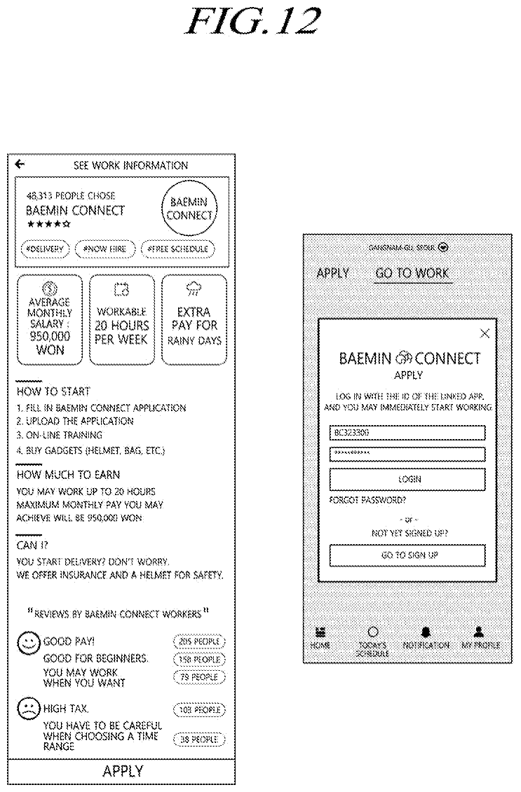

FIG. 12 illustrates a user interface to output detailed information about a recommended job and receive a job application according to an embodiment of the present invention.

Through the illustrated example, the worker may identify detailed information about the recommended job and apply for the job.

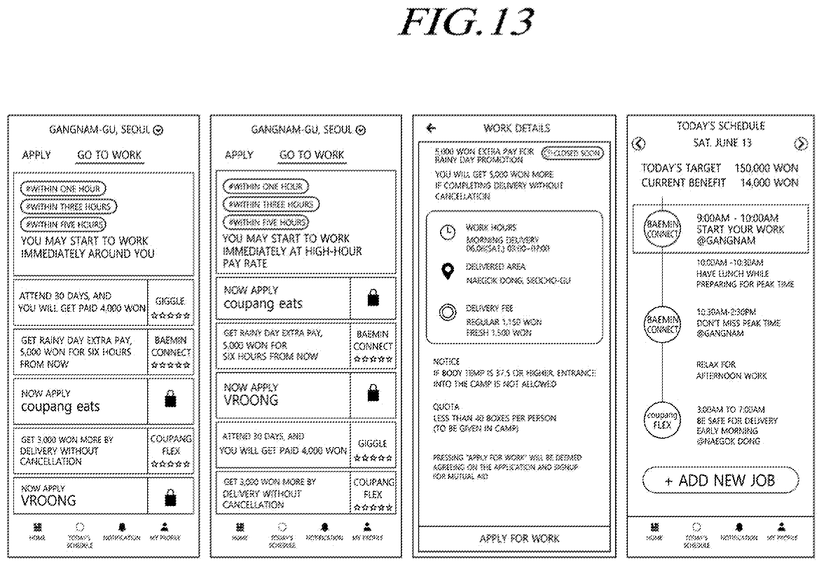

FIG. 13 illustrates a user interface to apply for a predetermined standard of job according to an embodiment of the present invention.

In the illustrated example, the worker may search for jobs and tasks that meet certain criteria (e.g., the nearest location, the highest hourly wage) and apply for the job. The worker may search “Today's schedule” for the applied-for job and task and add a new task.

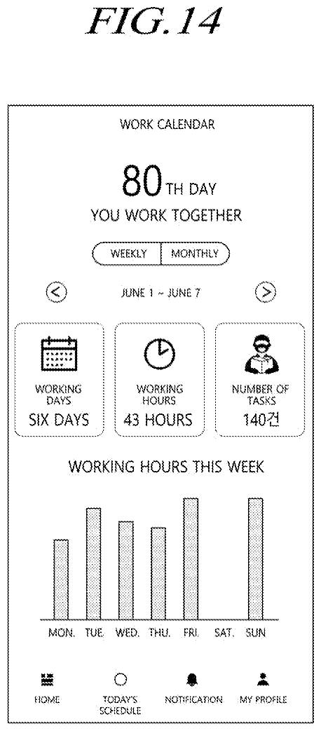

FIG. 14 illustrates a user interface to output work history information about a specific job according to an embodiment of the present invention.

In the illustrated example, the worker may inquire work history information including the total working days, total working hours, total number of times of work, and daily working hours in a specific job for a predetermined period.

Although preferred embodiments of the present invention have been described above in detail, the scope of the present invention is not limited thereto, and various modifications and equivalent other embodiments are possible. Thus, the true technical scope of the present invention should be defined by the appended claims.

For example, a device according to an example embodiment of the present invention may include a bus coupled to each of the units of the device as shown, and at least one processor coupled to the bus and may include a memory coupled to the bus to store commands, received messages, or generated messages and coupled to the at least one processor to perform the above-described commands.

Further, the system according to the present invention may be implemented as computer-readable code in a recording medium. The computer-readable recording medium includes all types of recording devices storing data readable by a computer system. The computer-readable recording medium includes a magnetic storage medium (e.g., a ROM, a floppy disk, or a hard disk) or an optical reading medium (e.g., a CD-ROM or a DVD). Further, the computer-readable recording medium may be distributed to computer systems connected via a network, and computer-readable codes may be stored and executed in a distributed manner.

1. A stable salary providing system, comprising:
an input unit receiving a payday of a predetermined cycle based on an external input;
a learning data obtaining unit obtaining learning data including worker information, work history information, and salary history information, based on an external input;
a future credit period obtaining unit determining a future credit period based on at least one of the learning data;
a future income predicting unit performing machine learning using at least one of the learning data and predicting future income for the future credit period; and
a virtual salary determining unit determining a virtual salary obtained by compensating for a deficit in a target salary based on the future income when a worker's salary at a specific pay time is less than the target salary.

2. The stable salary providing system of claim 1, wherein the target salary is input based on an external input by the input unit or is determined using at least one of the learning data.

3. The stable salary providing system of claim 1, wherein the future income predicting unit predicts a plurality of future salaries respectively for a plurality of paydays of the predetermined cycle within the future credit period and predicts a sum of the plurality of future salaries within the future credit period as the future income.

4. The stable salary providing system of claim 3, wherein the future income predicting unit calculates the future income minus the sum of the plurality of target salaries within the future credit period as a future credit limit.

5. The stable salary providing system of claim 4, further comprising a target salary adjustment unit reducing the target salary by a predetermined rate when the future credit limit is 0 or less, wherein the future income predicting unit calculates the future income minus the sum of the plurality of reduced target salaries within the future credit period as the future credit limit.

6. The stable salary providing system of claim 5, wherein the future income predicting unit determines a minimum target salary based on one of an external input, the learning data, and the target salary, and wherein the reduction of the target salary by the target salary adjustment unit and the calculation of the future credit limit by the future income predicting unit when the future credit limit is 0 or less are repeated when the reduced target salary is larger than the minimum target salary.

7. The stable salary providing system of claim 4, wherein the virtual salary determining unit determines the virtual salary obtained by compensating for the smaller of the deficit and the future credit limit in the salary.

8. The stable salary providing system of claim 7, further comprising a loan unit automatically generating a loan using the smaller of the deficit and the future credit limit as a loan amount, wherein the virtual salary is the salary plus the loan amount.

9. The stable salary providing system of claim 7, further comprising an investment linking unit further providing a user interface to link a remainder of the future credit limit, not covered in the virtual salary, as a first investment amount, to an investment product or automatically investing in a predetermined investment product.

10. The stable salary providing system of claim 9, wherein when the worker's salary exceeds the target salary, the investment linking unit further provides a user interface to link the excess, as a second investment amount, to an investment product or automatically invests in a predetermined investment product.

11. The stable salary providing system of claim 4, further comprising an information providing unit providing job information or recommending a job.

12. The stable salary providing system of claim 11, wherein the worker information includes at least one of age, gender, photo, location information, preferred occupation, preferred area, and preferred time range, wherein the work history information includes at least one of working days, working hours, and working patterns indicating working hours for a predetermined period, and wherein the salary history information includes at least one of a plurality of past salary amounts and a salary pattern indicating salary amounts for a predetermined period.

13. The stable salary providing system of claim 12, wherein the information providing unit provides job information or recommends a job based on at least one of the worker information, the work history information, and the salary history information when the worker's salary is less than the target salary or the future credit limit is 0 or less.

14. A stable salary providing method, comprising:
receiving a payday of a predetermined cycle based on an external input, by an input unit;
obtaining learning data including worker information, work history information, and salary history information, based on an external input, by a learning data obtaining unit;
determining a future credit period based on at least one of the learning data, by a future credit period obtaining unit;
performing machine learning using at least one of the learning data and predicting future income for the future credit period, by a future income predicting unit; and
determining a virtual salary obtained by compensating for a deficit in a target salary based on the future income when a worker's salary at a specific pay time is less than the target salary, by a virtual salary determining unit.

15. A computer-readable recording medium recording a program for performing the method of claim 14.
